(19) United States
(12) Patent Application Publication
(10) Pub. No.: US 2002/0074852 A1
(43) Pub. Date: Jun. 20, 2002

(54) Mechanical fuse for vehicle drive train

(76) Inventors: Olin L. Scrivens, Clackamas, OR (US); Thomas M. Telford, Gladstone, OR (US); John J. Harsany, Corvallis, OR (US)

Correspondence Address: Robert L. Harrington, Pacwest Center, Suite 1920, 1211 S.W. Fifth Avenue, Portland, OR, 97204-3713, US

(21) Appl. No.: 09/739,927

(22) Filed: Dec. 18, 2000

(51) Int. Cl. B60B 19/00

(52) U.S. Cl. 301/6.5

(57) ABSTRACT

A vehicle preferably having a wheel set convertible between driven and non-driven mode via clutch ring engagement/disengagement of the wheel hub and the axle. The clutch ring or other coupling component is readily replaceable in the field through manual removal of a removable cap enclosing said clutch ring or other coupling component, said coupling component exposed to the wheel exterior upon removal of the cap. The clutch ring or coupling component is designed to be the weakest link and to thereby fail upon excessive torque loading of the drive line before other drive line components fail and thereby enable in-field repair.

### FIELD OF THE INVENTION

This invention relates to the drive line of a four-wheel drive vehicle and more particularly it provides a readily reparable and inexpensive component of the drive line that is rendered breakable in conditions of high torque loading to thereby protect against breakage of components that are more expensive and more difficult to repair.

### BACKGROUND OF THE INVENTION

Four-wheel drive vehicles are often used for recreational purposes whereby the vehicle is driven off road and in rough terrain, the terrain including ruts and holes and mud and hills. The vehicle is driven aggressively and put to the ultimate test of durability. What often happens is that a component of the drive line breaks. It can be an axle, a U-joint or other component. Typically spare parts are carried by the driver and if the right part is broken and if the right tools are available and if the driver has the appropriate skills, he/she can repair the vehicle in the field and be on their way again. Otherwise the vehicle has to be towed to a repair shop for repair, ending that day's adventure.

### BRIEF DESCRIPTION OF THE INVENTION

A large percentage of the four-wheel drive vehicles used for such off road recreation are equipped with hub locks or hub lock mechanism located in the wheel hub of the front wheels which enables the driver to manually convert the vehicle between four-wheel drive and two-wheel drive. The hub locks interconnect the front wheel axles with the front wheel hubs. For example, a clutch ring is slidably connected to a hub body that is rotatably fixed to the wheel hub, the hub body and clutch ring having matching splines on the interior of the hub body and exterior of the clutch ring. The clutch ring is axially slidable into and out of engagement with an axle (which projects into the hub body) via matching splines on the exterior of the axle and interior of the clutch ring. Such movement of the clutch ring may be automatic or manual. For manual movement, a dial is exposed to the wheel exterior. Manual turning thereof produces sliding movement of the clutch ring to convert the drive mode of the vehicle between two-wheel drive and four-wheel drive.

The hub lock mechanism for manual actuation (and available for automatic actuation) is readily accessible for repair. Several bolts secure the hub lock mechanism to the wheel hub (bolted to the hub body) rendering the mechanism available for removal at the wheel exterior. With the bolts removed, a housing cap and the mechanism associated with the cap can be pulled free of the hub body which exposes the clutch ring. Should the clutch ring be broken, it can be easily removed and replaced, the entire process taking mere minutes of time. The clutch ring cost is measured in a few dollars and the entire repair is relatively painless (time wise and cost wise) as compared, e.g., to replacing a broken U-joint or axle.

The clutch ring does not, however, typically break during four-wheel drive abuse. It is far more common that other components in the drive line break before the clutch ring.

Breakage of a component of the drive line is a matter of creating a torque that exceeds the capability of the weakest component of the drive line. Often this is the U-joint which enables front wheel turning and particularly if the torque demand is created during a turn, i.e., with the wheels turned one direction or the other (left or right).

The invention in part is the recognition that the torque load whereat a component of the drive line will likely break can be determined. With that knowledge, the clutch ring can be designed to become the weakest component and when the vehicle is subjected to excessive abuse the clutch ring will break first, forcing shut down of the drive train before any other component of the system can break.

The above explanation has described how the clutch ring can be easily replaced due to the accessibility of the hub lock mechanism in the wheel hub. The clutch ring can thus be designed to also function as a mechanical fuse, i.e., it can be designed to fail when subjected to excessive loading at a torque load that safeguards other drive line components. However, the invention is not limited to the clutch ring component being the only component that can serve this function. As explained above, it is the mechanism of the hub lock in general that resides in the wheel hub and is accessible for removal and replacement. Accordingly, any part of the mechanism may assume the role of a mechanical fuse. It may be the hub body (or a separate sleeve of the hub body) or the drive gear which fits onto the axle and transmits torque from the axle to the clutch ring and hub body. Essentially it can be any component that is subjected to the torque load on the drive train and which is both readily accessible and replaceable through the wheel hub.

The invention will be more fully appreciated upon reference to the following detailed description having reference to the accompanying drawings.

### DESCRIPTION OF THE DRAWINGS

FIG. 1 is a schematic view of a vehicle chassis such as contemplated for the present invention;

FIG. 2 is a view of a wheel end indicating location and accessibility of the hub lock mechanism;

FIGS. 3A and 3B are detailed section views of the hub lock mechanism for illustrating its operation;

FIG. 4 illustrates the hub lock mechanism in a disassembled state as when removing and replacing a clutch ring;

FIG. 5 is a section view similar to FIG. 3A but illustrating a hub lock presently on the market; and

FIGS. 6 and 7 are views of the clutch rings of FIGS. 3A and 5 for comparison purposes.

### DETAILED DESCRIPTION OF THE PREFERRED EMBODIMENT

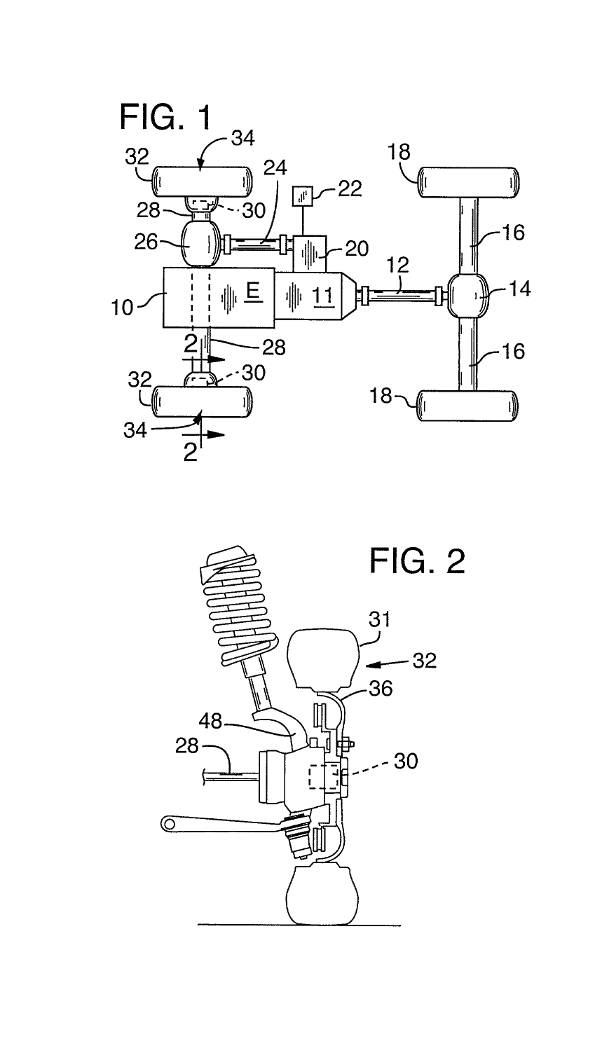

FIG. 1 illustrates the chassis of a convertible four-wheel to two-wheel drive vehicle. As typical for recreational four-wheel drive vehicles, an engine 10 having a transmission 11 drives a rear propellor shaft 12 which connects to a rear differential 14 which connects the propellor shaft to rear axles 16 for driving rear wheels 18. A transfer case 20 transfers drive power selectively (as determined by actuator 22) from the transmission 11 to front propellor shaft 24 connected to front differential 26. Front axles 28 extend into wheel hub 30 of front wheels 32 for selectively driving wheels 32.

In operation, while driving on a highway, the vehicle is typically driven in two-wheel drive mode, i.e., the rear wheels 18 are driven by the engine 10 via propellor shaft 12. In order to convert over to four-wheel drive, there are two points of connection for engagement between engine 10 and front wheels 32. A connect/disconnect is made within the transfer case 20 by activation of shift actuator 22. A second connect/disconnect is made between the axle and wheel hub 30. This second connection is made by engagement (manual or automatic) at each front wheel. In the manual version a dial at the outer side of the wheel hub is manipulated which is indicated by arrows 34.

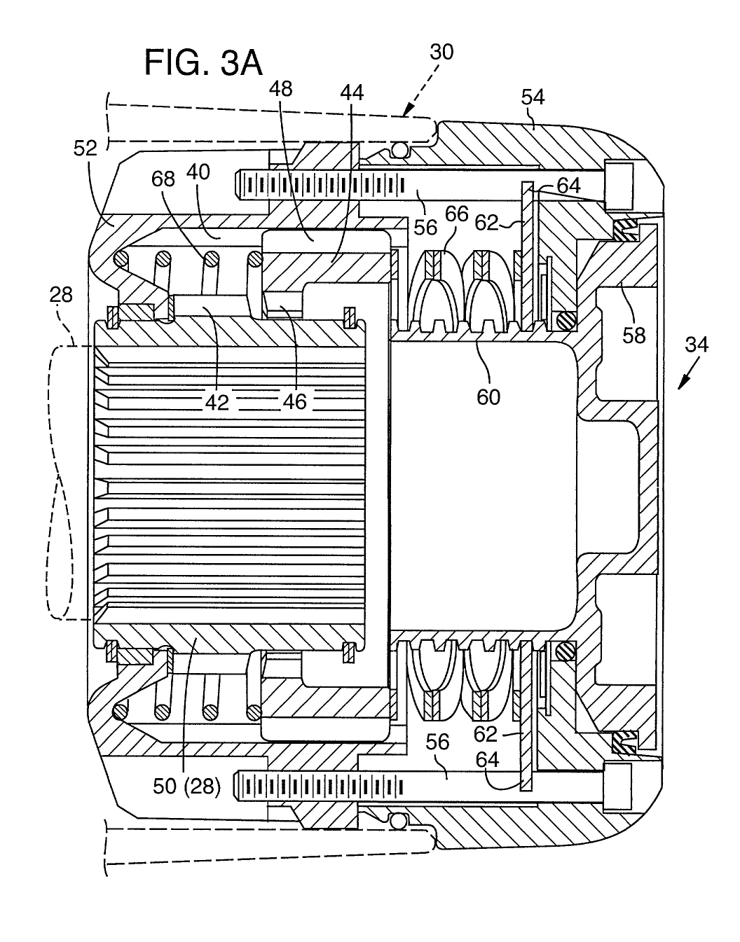

The desire for dual points of connection is well known to the art. If the wheel hub and axle of each of the front wheels are connected and the propellor shaft 24 is disconnected at transfer case 20 only, because the wheels are forced to rotate due to engagement with the road surface, the wheels then necessarily rotatively drive the front axles, front differential gears and front propellor shaft, causing unnecessary wear and consumption of energy. The connect/disconnect between wheel 32 and axle 28 is generally illustrated in FIG. 2. The wheel 32, comprised of tire 31 and wheel rim 36, is secured to wheel hub 30.

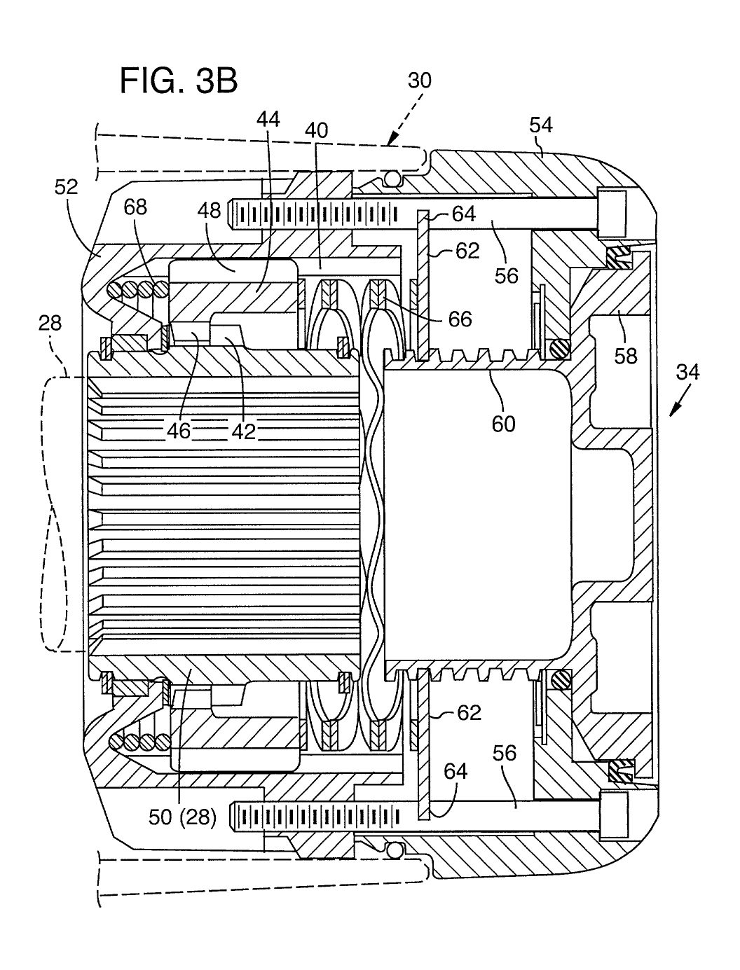

With reference to FIGS. 3A and 3B, illustrated is hub body 52 which is secured to a part of wheel hub 30 (shown in dash lines) in a known manner. Hub body 52 is provided with internal splines 40, and a drive gear 50 secured to axle 28 (also in dash lines) is provided with external splines 42. Interposed between splines 40 and 42 is a clutch ring 44 having internal splines 46 that match splines 42 of drive gear 50 and external splines 48 that match splines 40 of hub body 52.

A comparison is now made between FIGS. 3A and 3B for explanation of the hub lock mechanism in its two stages of engagement (connected and disconnected). The drive gear 50 is secured to the axle 28 and for purposes of explanation is a part of axle 28. The drive gear 50 carries the external splines 42. Similarly, hub body 52 is secured (e.g., spline fit) to the wheel hub and is a part of the wheel hub for purposes of the explanation. The hub body 52 carries the splines 40.

The splines 48 of clutch ring 44 slidably engage splines 40 of hub body 52 regardless of the axial position of the clutch ring. The internal splines 46 of clutch ring 44 move into and out of engagement with splines 42 of drive gear 50. In FIG. 3A the splines 46 and 42 are shown in a disengaged relation and in FIG. 3B the splines 46 and 42 are shown engaged.

Secured to the hub body 52 by bolts 56 is a cap 54. A manually actuated control dial 58 is rotatably mounted to the cap 54. Inwardly extended from the dial 58 is a threaded cylindrical portion 60. Clutch nut 62 is threadably engaged with the threads of cylindrical portion 60. The nut 62 is prevented from turning by ears 64 that engage bolts 66. Thus, as the dial 58 and thus the cylindrical portion 60 is turned in one direction, the nut is forced to slide axially inwardly as viewed in FIG. 3B, and when turned in the other direction the nut is forced outwardly as viewed in FIG. 3A.

The nut 62, in its inward travel, abuts against a wave spring 66 that in turn abuts against the clutch ring 44. Thus, as the dial 58 is turned to force the nut and thus the wave spring inwardly, the clutch ring is compliantly urged inwardly for engagement with the drive gear splines 42. A return coil spring 68 resists such movement but is overcome by the greater strength of the wave spring 66. By reverse turning of the dial 58, the nut 62 is backed away from the wave spring 66 allowing the coil spring 68 to urge return of the clutch ring to non-engagement.

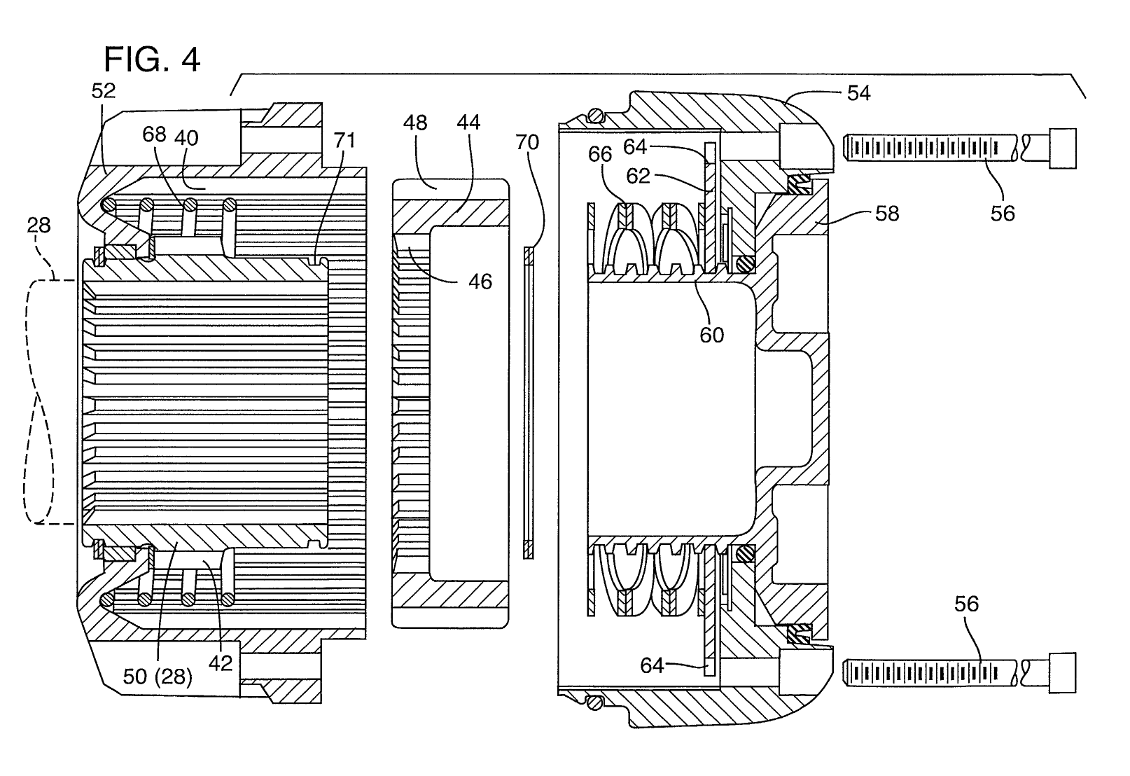

Disassembly of the cap 54 from the hub body 52 is illustrated in FIG. 4. By removing the bolts 56, the cap 54 can be pulled free of the hub body 52. With the cap comes the dial 58, nut 62 and wave spring 66, thus exposing the clutch ring 44. A retaining ring 70 in groove 71 prevents the clutch ring from simply being pushed out of the hub body by coil spring 68. The retaining ring 70 is removed to thereby remove and replace the clutch ring as desired. Reassembly is the above steps reversed. A new clutch ring is inserted in the hub body and the retaining ring 70 is replaced in groove 71 to hold it in place. The cap 54 and related components is placed on the hub body 52 and the bolts 56 are inserted into the threaded openings to lock the cap 54 back onto the hub body 52. It will be appreciated that all the above takes place without removal of the wheel.

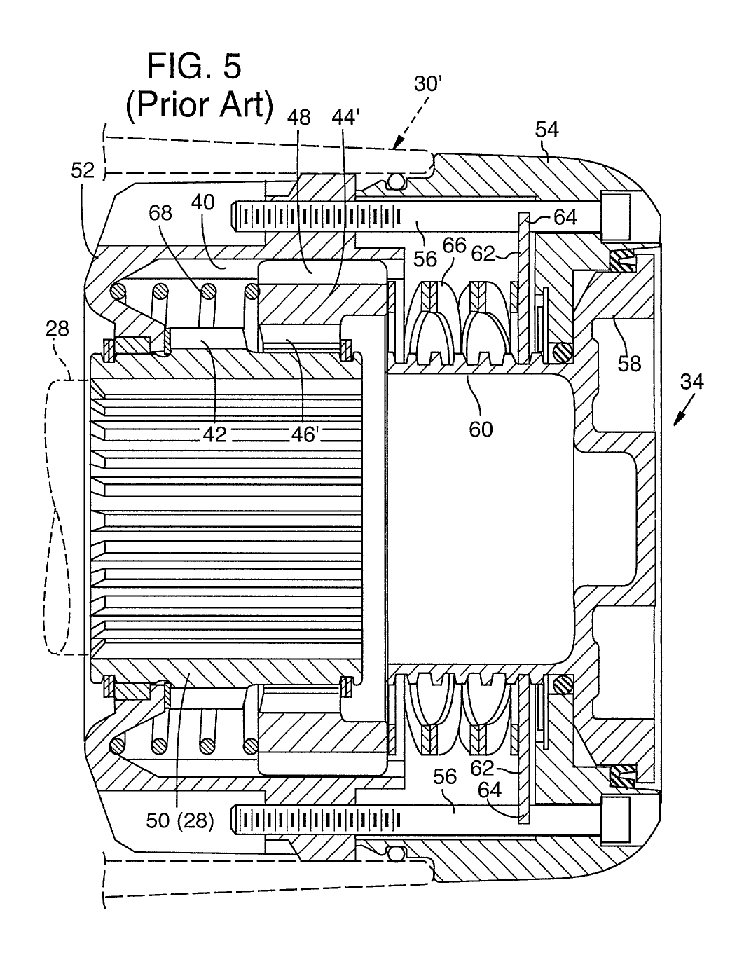

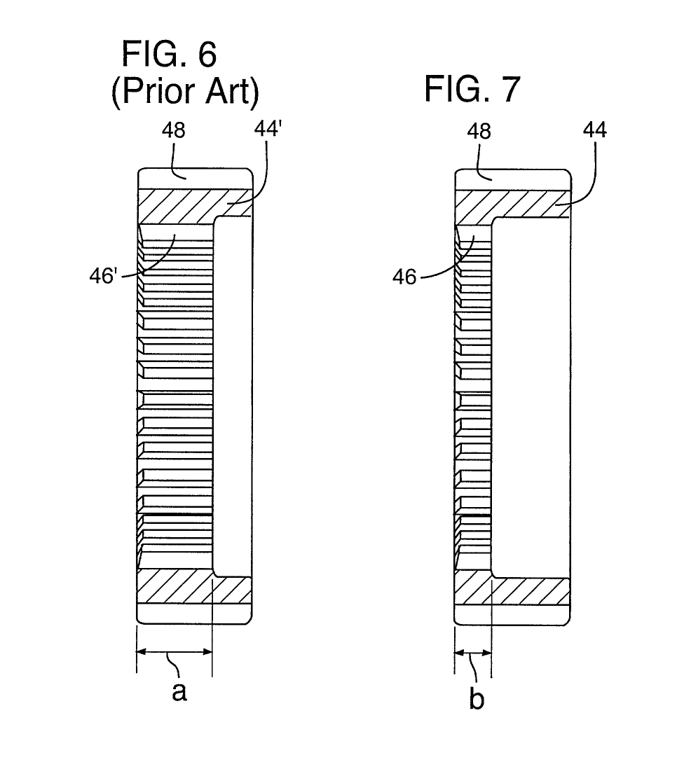

FIG. 5 illustrates a hub clutch (hub body, cap and internal components) which has been in use on recreational four-wheel drive vehicles such as contemplated for the present invention. The embodiment of FIG. 3A is patterned after the FIG. 5 hub clutch. The difference relates to the clutch ring identified as 44′ in FIG. 5 as compared to the clutch ring 44 in FIG. 3A. A direct comparison is made between the two clutch rings 44, 44′ in FIGS. 6 and 7.

The clutch ring 44′ of FIG. 6 was designed to withstand the torque demand generated by off road use of four-wheel drive vehicles. It is not typical that the clutch ring 44′ would break during off road use even when the vehicle is subjected to extreme abuse. Other components more readily break, e.g., the U-joint.

As explained, a clutch ring can be readily changed by a driver in the field with few tools. Changing a U-joint or axle is a major project and would likely require that the vehicle be towed to a repair shop. Accordingly, the object of the invention is to design the clutch ring so that it will break before an axle or U-joint breaks.

A study directed to a specific vehicle application was conducted and it was determined that most but not all drive line breakage of the particular vehicle tested occurred when encountering a torque load above about 46,000 inch-pounds. The exception applied primarily to the U-joint for the front wheels but only under certain conditions of driving. The U-joint (which enables turning of the front wheel) becomes more vulnerable to breakage as the steering angle of the front wheel increases. With the wheels turned beyond an angle of about 30 degrees, the U-joint was sufficiently weakened so that it would break when subjected to torque loads below 46,000 inch-pounds. However, it was further determined for that application that 46,000 inch-pounds is a desired minimum for the clutch ring. Should the clutch ring be designed to break at lesser torque loads, the incidence of breakage of the clutch ring is considered unacceptable.

Considering that excessive torque loading does not occur frequently with the wheels turned beyond 30 degrees, by protecting the drive line (of the tested vehicle) to the 46,000 inch-pounds torque load, under most aggressive driving conditions the clutch ring is the weakest link and will break before any other component. If the clutch ring is designed to break much below the 46,000 inch-pounds, the clutch ring will break too readily, i.e., during the more likely occasions of aggressive driving with the wheels straight or just slightly turned. The decision of where to set the clutch ring breakage threshold becomes a matter of whether to suffer more frequent occasions of having to replace the clutch ring or experiencing less frequent clutch ring replacement and suffering a higher likelihood of a major break down in an occasion of excessive torque (e.g., below 46,000 pounds for the vehicle tested) being applied with the wheels turned sharply.

At whatever the desired point of breakage, the clutch ring for that application is preferably designed so that the splines 44 will strip or break off at about the desired torque load, e.g., 46,000 inch-pounds. As illustrated in the comparison of FIGS. 6 and 7, a preferred way is to simply shorten the length of the splines, i.e., dimension “a” vs. dimension “b”. Whereas this illustrated reduction in length is about 50 percent, the goal is to achieve that reduced length which reduces the strength to a level whereat the splines will fail at the desired torque load thus uncoupling the hub from the axle for that wheel. Due to the effect of the gear design of the front differential, such uncoupling effectively decouples both front wheels from the front propellor shaft and the vehicle is effectively converted to two-wheel drive with essentially no torque applied to the front wheels. The entire front wheel drive line is rendered passive and the driver either continues in two-wheel drive or stops, unbolts and removes the cap 54, replaces the clutch ring, replaces and rebolts the cap and continues on his journey.

It will be understood that there are a number of ways to alternatively or accumulatively weaken the ability of the splines of the clutch ring to withstand torque load. Circumferential grooves could be cut into the splines. Certain of the splines could be totally removed, e.g., every other one or in groups of five or whatever pattern to achieve the desired result. The material of the splines could be weakened (use of a material with different properties, i.e., weaker or lesser mechanical properties, or by not heat treating the splines or certain of the splines, etc.).

The above disclosure of the invention is directed to using the clutch ring as the “mechanical fuse.” The advantage is that the clutch ring is a component that transmits torque from the axle to the wheel, it is readily accessible for replacement through disassembly of the hub lock and it is a low cost item. There are, however, other components that can serve this same purpose. For example, the drive gear 50 is or can be made to be accessible upon removal of the cap 54 and its internal components and then the clutch ring 44 and spring 68. By reducing the strength of the splines 42 (rather than splines 46 of the clutch ring), the drive gear 50 is made the “mechanical fuse” and it can be replaced upon failure. It is also quite conceivable that the hub body 52 can be structured to have an inner sleeve that is designed to be the fuse component or even the hub body itself can serve that function. These and other variations will occur to those skilled in the art and accordingly the invention is not limited to the above specific disclosures but encompasses the definition of the claims appended hereto. In particular, it is intended that the claims are not to be interpreted as written in means plus function format under 35 USC §112, ¶16.

The invention claimed is:

1. In a vehicle, a system for controlling drive line failure comprising:
a wheel having a wheel hub;
an axle forming one of a number of components of the vehicle's drive line and extended into adjacent relation to the wheel hub;
a coupler coupling the wheel hub and axle;
an opening into the wheel hub enabling access to the coupler for removing and replacing said coupler;
said coupler configured to fail upon application of a determined torque load, said determined torque load established to protect other of the drive line components.

2. A system as defined in claim 1 wherein the coupler is a clutch ring movable between positions of non-coupling relation and coupled relation as between the wheel hub and axle, an actuator for moving said clutch ring between said positions and a removable cap covering said opening.

3. A system as defined in claim 2 wherein said cap comprises a manual rotatable dial as the actuator, said dial upon rotation inducing axial movement of the clutch ring.

4. A system as defined in claim 1 wherein one of the wheel hub and axle is provided with a drive gear sleeve, said drive gear sleeve being the coupler and accordingly designed to fail at a determined torque load.

5. In a vehicle, a system for controlling drive line breakage comprising:
a wheel, a wheel hub supporting the wheel, an axle forming a part of said drive line and projected into said wheel hub, said wheel hub having inwardly directed axially oriented splines and said axle having outwardly directed axially oriented splines proximal to the splines of the wheel hub, and a clutch ring having outer and inner spline sets for slidable continued engagement with one of the axle splines and wheel hub splines and axially movable into and out of engagement with the other of the axle splines and wheel hub splines to produce selective engagement of the axle and wheel hub and accordingly engagement of the drive line and wheel;
said drive line consisting of a plurality of components through which torque is transmitted as between a motor and the wheel with the drive line and wheel in engagement whereby said clutch ring provides one of said plurality of components;
said inner and outer spline sets of said clutch ring subjected to rotatively applied stress upon application of said torque, and one of said inner and outer spline sets structured to intentionally fail at a pre-determined torque load to thereby disengage the drive line and wheel and accordingly release the drive torque applied to the drive line components;
said pre-determined torque load being less than the torque load required to break any other of the components in said drive line.

6. A system as defined in claim 5 including a U-joint forming part of the drive line for enabling turning of the wheel, said wheel in being turned reducing the U-joint's ability to withstand torque load and defining thereby a range of torque load tolerance between straight and full turn of the wheel, said pre-determined torque load being intermediate in said range of torque load tolerances.

7. A system as defined in claim 6 wherein the pre-determined torque lead is substantially at the point of torque load tolerance with the wheel turned about 30 degrees from a generally forwardly or rearwardly directed path.

8. A system as defined in claim 5 wherein the pre-determined torque is about 46,000 inch-pounds.

9. A system as defined in claim 5 wherein the hub comprises a hub body and a cap removably secured to the hub body, said cap exposed to the wheel exterior for manual removal and upon removal for exposure and replacement of the clutch ring to thereby reinstate drive torque to the drive line components.
